(19) United States
(12) Patent Application Publication
(10) Pub. No.: US 2011/0090047 A1
(43) Pub. Date: Apr. 21, 2011

(54) Biometric switch and indicating means

(76) Inventor: Pankaj B. Patel, Nashua, NH (US)

(21) Appl. No.: 09/785,775

(22) Filed: Feb. 20, 2001

(51) Int. Cl. G06F 7/04

(52) U.S. Cl. 340/5.82

(57) ABSTRACT

A biometric switch for reading fingerprints, giving tactile feedback when the fingerprint has been read, and opening a locking mechanism when depressed. The biometric mechanisms are encased into a small push button type switch with the finger print reader at the top surface. When the fingerprint is read and the processor has determined that the user is allowed access, the button is allowed to depress via an electromechanical mechanism. Thus the invention allows for the inherent force of the fingerprint pressed against the button to open a variety of devices.

### BACKGROUND

1. Field of the Invention

Generally, this invention is directed towards a biometric switch for notifying a person that a biometric device has been properly activated. More specifically, this invention is a biometric switch for fingerprint sensors and readers used in conjunction with appropriate software and audio and visual indicating means to notify and teach a user that the user has given a proper amount of finger print pressure to the finger print reader via tactile feedback.

2. Description of the Prior Art

Finger print readers and biometrics in general have been entering the private market place at a rapid rate. The software and technology associated with these finger print readers has grown dramatically and more accurate over the recent years. Many businesses today are capitalizing on this increased level of security, inexpensive and ease of application. However, there exist a small problem with finger print readers, in that they are still relatively new in the private sector, which means some people must be taught or coached in exactly how to use them properly. To accurately read a fingerprint from a person's finger, a proper amount of surface area needs to be abutted against the finger print reader. Some people might feel a little timid when dealing with this new technology and not press hard enough on the finger print reader for an accurate reading. Others might press hard enough, but not press long enough on the finger print reader to allow for the processor and software to obtain an accurate reading. Thus a device needs to be integrated into finger print readers that will teach and notify a person when he/she has applied enough pressure and allowed enough time to elapse for the finger print reader to accurately read the fingerprint.

Several approaches have been provided for finger print sensing devices, in U.S. Pat. No. 5,852,670, “A fingerprint sensing device includes a fingerprint sensor, a processor for determining an actual fingerprint position on the fingerprint sensor relative to a desired fingerprint position, and a finger position indicator for generating a finger position indication to assist the user in positioning the finger to the desired fingerprint position based upon the actual fingerprint position on the fingerprint sensor. The processor preferably calculates a fingerprint center point defining the actual fingerprint position. The fingerprint sensor may be provided by an electric field sensor in integrated circuit form. The finger position indicator may be provided by a visual indicator, such as a desired position image indicia generator for generating image indicia on a display screen relating to the desired fingerprint position on the fingerprint sensor, and wherein an actual fingerprint position image is also generated relative to the desired position image indicia on the display screen. The desired position image indicia may preferably be a desired fingerprint center point indicia image. Method aspects of the invention are also disclosed.”

In the art taught by U.S. Pat. No. 5,828,773, “A fingerprint sensing device includes a fingerprint sensor, a processor for determining an actual fingerprint position on the fingerprint sensor relative to a desired fingerprint position, and a finger position indicator for generating a finger position indication to assist the user in positioning the finger to the desired fingerprint position based upon the actual fingerprint position on the fingerprint sensor. The processor preferably calculates a fingerprint center point defining the actual fingerprint position. The fingerprint sensor may be provided by an electric field sensor in integrated circuit form. The finger position indicator may be provided by a visual indicator, such as a desired position image indicia generator for generating image indicia on a display screen relating to the desired fingerprint position on the fingerprint sensor, and wherein an actual fingerprint position image is also generated relative to the desired position image indicia on the display screen. The desired position image indicia may preferably be a desired fingerprint center point indicia image. Method aspects of the invention are also disclosed.”

In U.S. Pat. No. 5,963,679, “A fingerprint sensor includes an array of electric field sensing electrodes, a dielectric layer on the sensing electrodes with the dielectric layer for receiving a finger adjacent thereto, and a driver for applying an electric field drive signal to the sensing electrodes and adjacent portions of the finger so that the sensing electrodes produce a fingerprint image output signal. In one embodiment of the invention, the driver provides a coherent drive signal for the array. A respective shield electrode may be associated with each of the electric field sensing electrodes for shielding each electric field sensing electrode from adjacent sensing electrodes. Each shield electrode may be actively driven for further shielding. The fingerprint sensor preferably further includes a synchronous demodulator and contrast enhancer for more accurate output image signals. The fingerprint sensor may be effectively used to control access to a computer workstation. Method aspects are also disclosed.”

While some of the prior art may contain some similarities and common components relating to the present invention, none of them teach, suggest or include all of the advantages and unique features of a finger print indicating device and means of notifying a user when the proper amount of surface area and the proper amount of time have been applied to the finger print reader for accurate readings.

### SUMMARY

The present invention is directed towards an apparatus for encasing biometric technology into a small push button type switch, in addition to teaching and notifying a user how to properly apply his/her finger print to a finger print reader. The encased biometric switch allows for all of the primary components to be housed into a small-miniaturized casing such as a switch or button. Furthermore, this invention allows for the inherent force that is normally applied to the fingerprint reading surface to perform a secondary function of opening a mechanical locking mechanism and to notify the user that the fingerprint has been read and verified. The invention basically consist of the following components working in conjunction with one another such as a finger print reader, a visual indicator, an audio indicator, a processor, a memory storage, and a mechanical mechanism activated when a proper finger print reading has been obtained.

Accordingly, it is a general object of this invention to provide an apparatus for notifying an individual that he/she has applied the correct amount of pressure to the finger print reader for allowing accurate readings.

Another object of this invention is to provide an apparatus for notifying an individual that he/she has applied the correct amount of pressure to the finger print reader for the correct length of time for allowing accurate readings. In other words, the invention takes the guesswork out for the operator as to how long he/she needs to hold the finger down onto the surface of the finger print reader.

Still another object of this invention is to provide an apparatus using software to determine the correct amount of finger print surface area applied to the finger print reader before signaling an audio and visual indicator.

A further object of this invention is to provide an apparatus using a mechanical mechanism that activates when proper finger print pressure or surface area has been obtained for a correct given amount of time. In addition, the reader allows for physical movement of a switch or button when both these parameters have been obtained.

Still a further object of this invention is to house all of the components of biometric technology into a small mechanical switch.

Other objects and a fuller understanding of the invention will become apparent from reading the following detailed Description of a preferred embodiment in conjunction with the accompanying drawings.

### BRIEF DESCRIPTION OF THE DRAWINGS

This invention, together with other objects, features, aspects and advantages thereof, will be more clearly understood from the following description, considered in conjunction with the accompanying drawings.

Fifteen sheets of drawings are furnished, sheet one contains FIG. 1, sheet two contains FIG. 2, sheet three contains FIG. 3, sheet four contains FIG. 4, sheet five contains FIG. 5, sheet six contains FIG. 6, sheet seven contains FIG. 7, sheet eight contains FIG. 8, sheet nine contains FIG. 9, sheet ten contains FIG. 10, sheet eleven contains FIG. 11, sheet twelve contains FIG. 12, sheet thirteen contains FIG. 13, sheet fourteen contains FIG. 14, and sheet fifteen contains FIG. 15.

FIG. 1 shows a top view of a finger being applied to a finger print reader with audio and visual indicators indicating an accurate reading from the fingerprint.

FIG. 2 shows a block flow diagram of the general components used in relationship to one another.

FIG. 3 shows two views, one view showing a block flow diagram and the other view showing a top view of a finger print sensor. In this Figure, the finger is not in contact with the finger print sensor, therefore the audio and visual indicators are off.

FIG. 4 shows two views, one view showing a block flow diagram and the other view showing a top view of a finger print sensor. In this Figure, the finger is in contact with the finger print sensor, however, the finger pressure is insufficient to obtain an adequate surface area reading, therefore the audio and visual indicators are in the off position.

FIG. 5 shows two views, one view showing a block flow diagram and the other view showing a top view of a finger print sensor. In this Figure, the finger is in contact with the fingerprint sensor contains adequate pressure, thus, the audio and visual indicators are in the on position.

FIG. 6 shows two views, one view showing a block flow diagram and the other view showing a side cutaway view of a mechanical trigger mechanism. In this Figure, the finger is in contact with the finger print sensor and contains adequate pressure, thus, the mechanical mechanism allows for the finger print sensor to physical depress thereby notifying the user that the fingerprint has been read accurately.

FIG. 7 shows two views, one view showing a block flow diagram and the other view showing a side cutaway view of a mechanical trigger mechanism. In this Figure, the finger is in contact with the finger print sensor and does not contain adequate pressure, thus, the mechanical mechanism is locked in the upward position and not allowed to depress as in FIG. 6.

FIG. 8 shows a side cut-away view of a finger with the finger print surface about to come in contact with the biometric finger print reader. The cut-away section shows the primary components of the biometrics housed inside the switch. Note, a pair of locking pins is shown preventing the switch from being pressed downward.

FIG. 9 shows a side cut-away view of a finger with the finger print surface in partial contact with the biometric finger print reader. Here again we see the cut-away section shows the primary components of the biometrics housed inside the switch. Again the pair of locking pins is shown preventing the switch from being pressed downward.

FIG. 10 shows a side cut-away view of a finger with the finger print surface in full contact with the biometric finger print reader. Here again we see the cut-away section shows the primary components of the biometrics housed inside the switch. In this case, the fingerprint has been biometrically read and the locking pins have been electronically removed allowing the switch to be pressed downward.

FIG. 11 shows a top view of a padlock with a biometric finger print reader integrated on the top front surface and replacing the typical numeric dial.

FIG. 12 shows a top view of a padlock with a biometric finger print reader integrated on the top front surface and a finger placed on the surface of the finger print reader.

FIG. 13 shows a top view of a padlock with a biometric finger print reader integrated on the top front surface and a finger placed on the surface of the finger print reader and the lock in an unlocked position.

FIG. 14 shows a side cut-away view of a finger with the finger print surface in partial contact with the biometric finger print reader. Here we see the cut-away section showing the primary components of the biometrics housed inside the switch. Note, the electric switch or solenoid is now at remote sites.

FIG. 15 shows a side cut-away view of a finger with the finger print surface in full contact with the biometric finger print reader.

### LIST OF ELEMENTS

### 1. FINGER PRINT READER APPARATUS

### 2. FINGER PRINT READER

### 3. AUDIO INDICATOR

### 4. FINGER PRINT HOUSING

### 5. FINGER

### 6. KNUCKLE

### 7. FINGER TIP

### 8. FINGER PRINT

### 9. FINGERPRINT SENSOR

### 10. ELECTRICAL CONNECTION

### 11. MEMORY STORAGE

### 12. PROCESSOR

### 13. DATA LINK

### 14. POWER LINK

### 15. TRANSPARENT MEDIUM

### 16. VISUAL INDICATOR

### 17. AUDIO SIGNAL

### 18. VISUAL SIGNAL

### 19. TIP OF FINGER PRINT

### 20. FULL FINGER PRINT

### 21. SPRING

### 22. LOCKING PIN HOUSING

### 23. SOLENOID

### 24. LOCKING PIN

### 25. POWER LINE

### 26. DATA LINE

### 27. LEVER ARM

### 28. TOP LATCH

### 29. BOTTOM LATCH

### 30. PIVOT HINGE

### 31. STEEL HARDENED LOCK

### 32. PADLOCK HOUSING

### 33. LATCH

### DESCRIPTION OF THE PREFERRED EMBODIMENTS

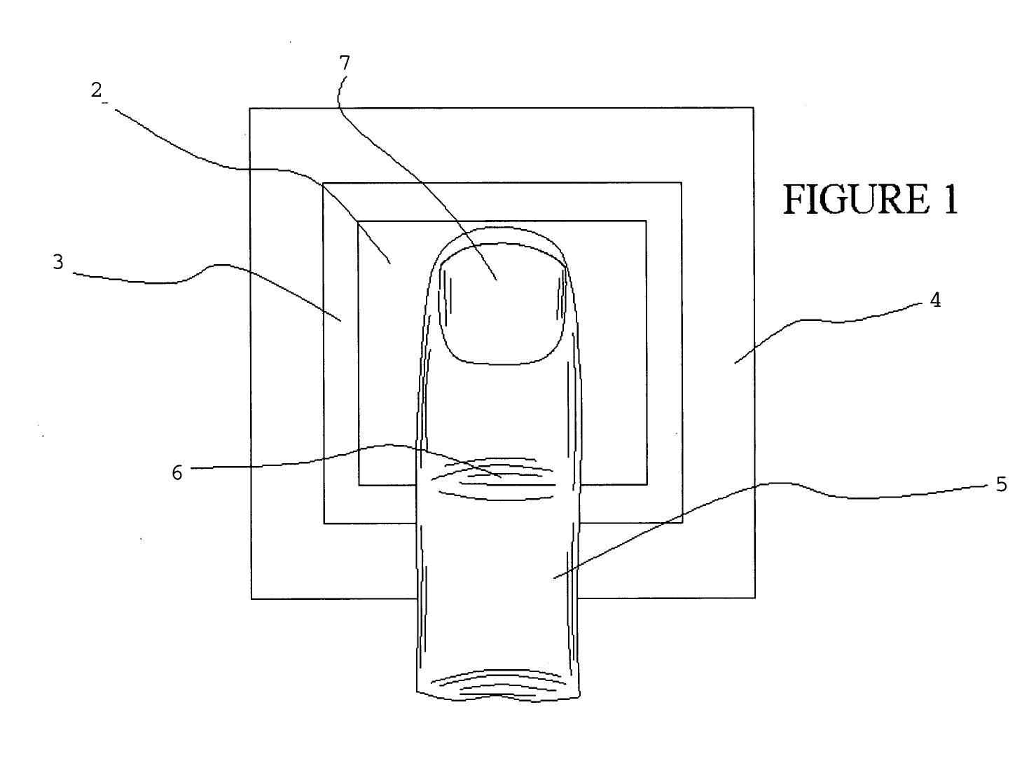

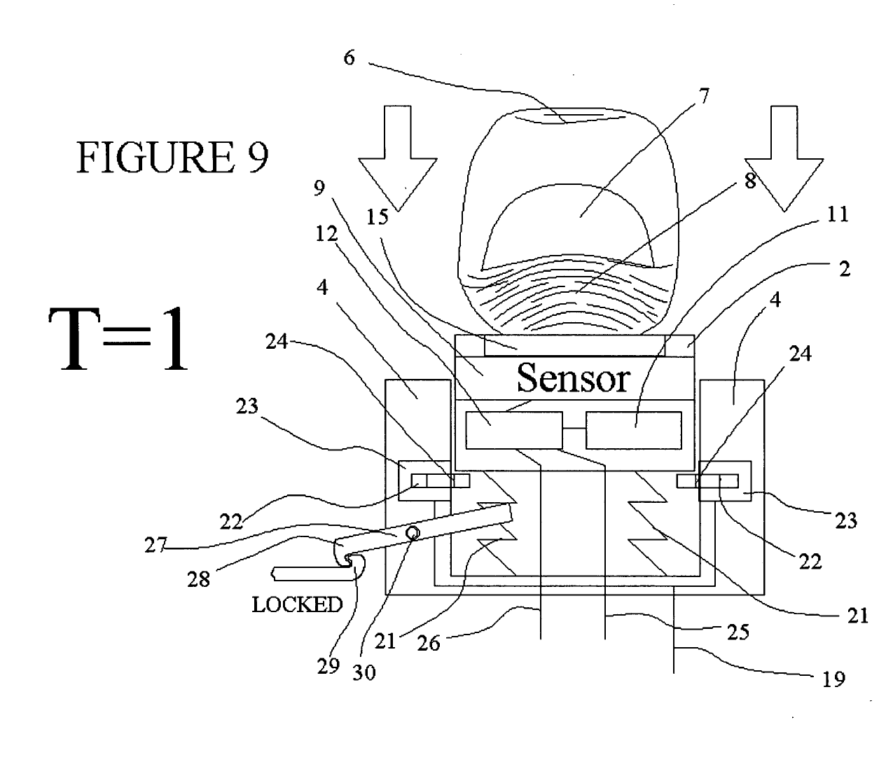

In FIGS. 1-10, the primary components of the invention are shown and how they are interrelated with one another. FIG. 1 shows a top view of a fingertip 7 of finger 5 pressed against the readable surface/finger print reader 2 of the bioswitch. An audio indicator 3 and housing 4 are positioned along the perimeter of the finger print reader 2.

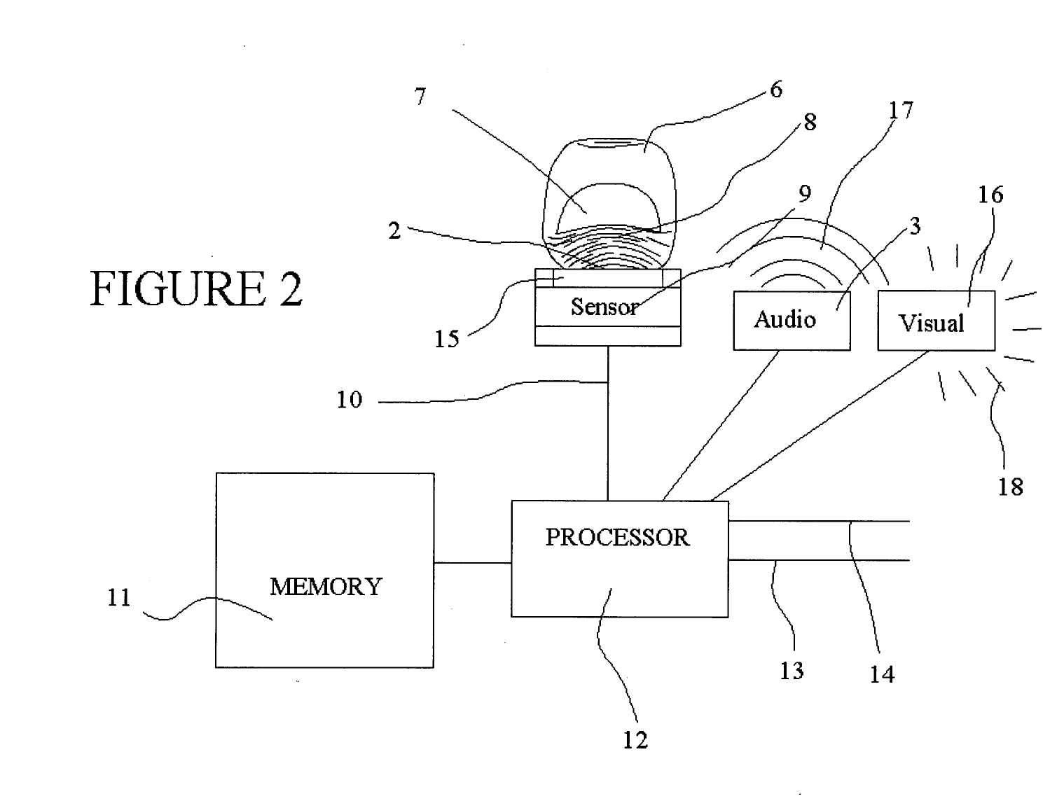

FIG. 2 shows a block flow diagram of primary components used in the bioswitch. A biometric fingerprint reader 2 is electrically connected to a processor 12, when the finger print 8 from the finger 5 is properly read and analyzed from pre-stored data in memory storage 11, the processor 12 then activates one or both audio and visual sensors 3 and 16 respectively. The person who is placing his/her finger 5 on the fingerprint reader 2 is then notified via audio 3 and visual 16 indicators that he/she can therefore remove their finger 5. Also the action of placing the finger 5 and pressing on the reader 2 creates a natural inward motion like a regular switch. By the time the switch is fully pressed and Released the processor 12 will read, analyze, activate sensors and validate the user by opening the Locking pin. The components shown in FIG. 2 are typically powered by power links 14; however, most of the finger print readers 2 may be in a remote location whereby an internal power supply will be used. Also included in FIG. 2 is a data link 13, which will transmit or retrieve encrypted information to and from remote locations either through the use of the computer, hand held devices, Internet or other means.

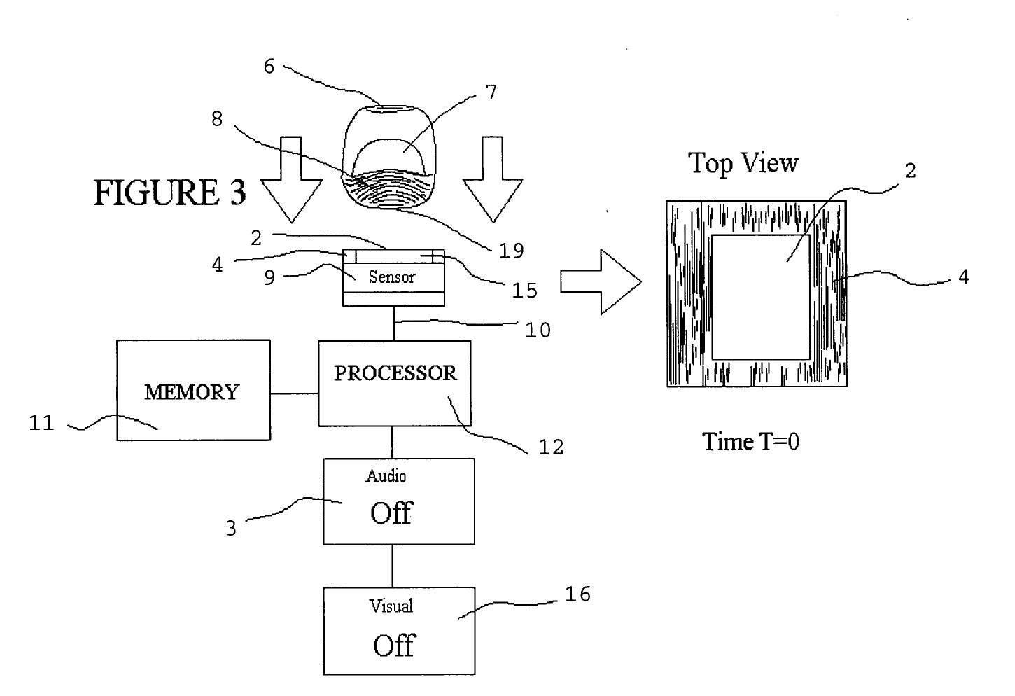

FIGS. 3-5 show a time lapsed block flow diagram and top view of the finger print scanner. The top view of the finger print reader 2 shows only the fingerprint 8 of finger 5 as would be seen from the reader 2 when the fingerprint 8 is applied against the surface of reader 2. FIG. 3 shows at time T=0 no fingerprint 8 or portion of finger print 8 because the fingerprint has yet to be applied to the surface of the reader 2.

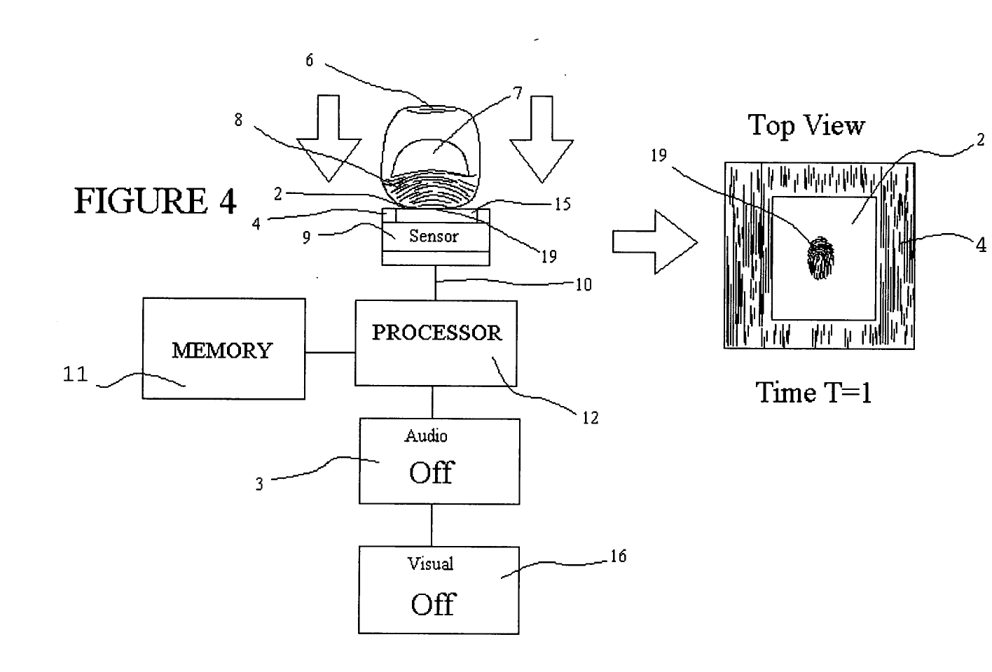

In FIG. 4, at time T=1, the finger print 8 has made and initial contact with the reader 2, thus, only a portion of the finger print 19 or tip of finger print 19 is read on finger print reader 2. The tip of finger print 19 at this point in time where T=1, is insufficient for the internal software or algorithms in memory storage 11 to ascertain whether or not the print 19 can be matched with previously stored finger print of the memory 11. Normally, an adequate number of minutia points from a finger print is needed for the internal software to process and match information from previously stored finger prints in memory 11. Since the proper amount of surface area of fingerprint 19 has not been achieved from finger 5, none of the audio or visual indicators are activated. This signals the user to press more firmly onto the surface of the finger print reader 2 to achieve an adequate reading. The natural motion of pressing a momentary open switch designed appropriately for adequate pressure ensures the user has pressed firmly to achieve adequate reading.

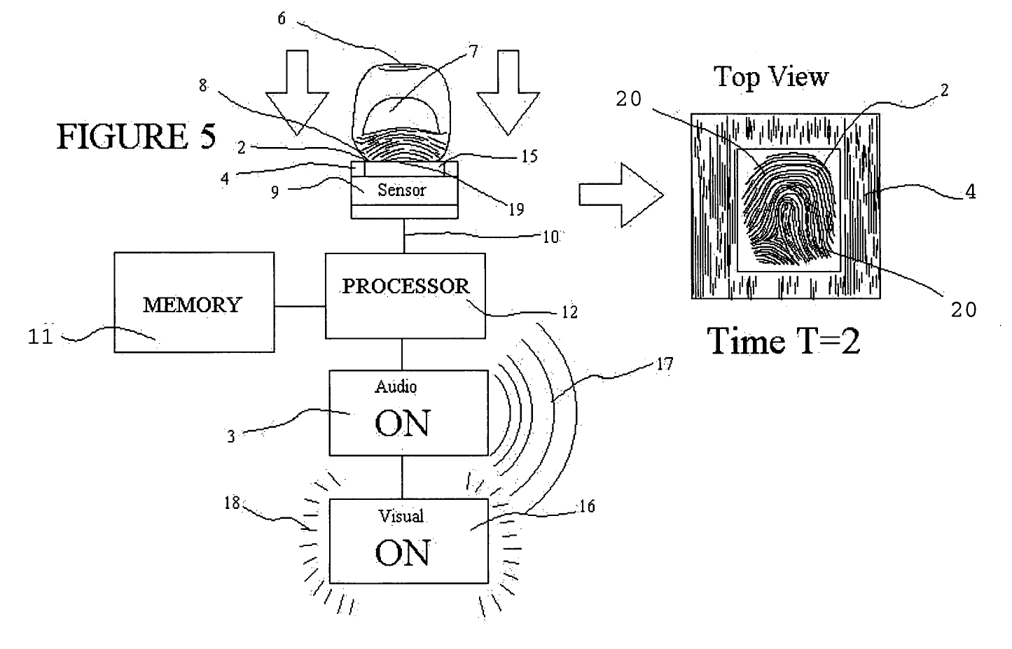

FIG. 5, at time T=2, shows the fingerprint 8 firmly pressed against the reader 2. The top view of the finger print reader 2 now shows a full finger print 20 with an adequate amount of minutia points for the internal software to process and match with internally stored finger prints of memory 11. Since the proper amount of pressure has been applied by finger 5 and the proper amount of surface area of fingerprint 20 has been processed, the audio 3 and visual 16 indicators are activated. The activation of the audio and visual indicators signals the user with audio 17 and visual 18 that he/she may remove his/her finger from the reader 2.

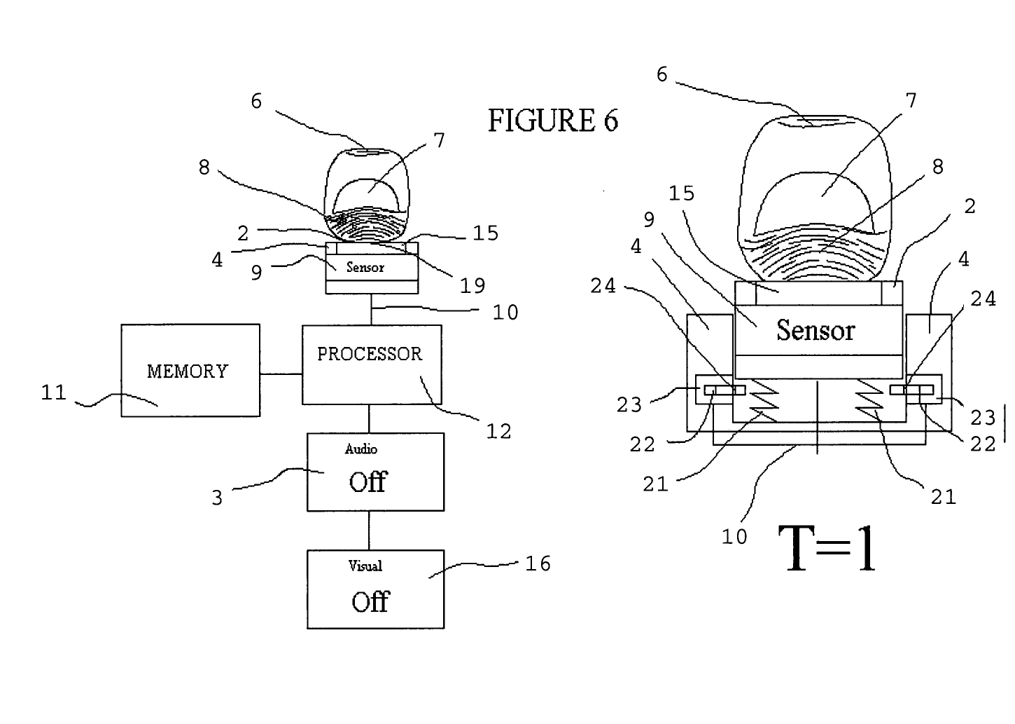

The proper amount of finger pressure to create an accurate reading from the finger print reader 2 creates another necessary integrated and inherent feature of the present invention. The present invention is intended to use the finger pressure that the finger 5 exhibits onto the finger print reader 2 to simultaneously open a mechanical, electromechanical or any other similar device immediately after the finger print has been read, processed and approved for authorized access. FIG. 6 shows the initial contact of fingerprint 8 onto reader 2 at time T=1. As in the previous figures, a block flow diagram show the primary components used during this sequence. To the right of the block flow diagram is an open view of the bioswitch exposing the general internal mechanisms of the bioswitch. The bioswitch contains a fingerprint reader slidably affixed to a fingerprint housing 4. A plurality of springs 21 are affixed to one end of the finger print reader 2 and the other end to the housing 4. The springs 21 keep the bioswitch in an upward position when no pressure is applied to the top surface of the finger print reader 2. A pair of locking pins 24 prevents the finger print reader 2 from sliding downward. The locking pins 24 are part of a solenoid mechanism 23, which is activated or deactivated when an authorized fingerprint 8 is read and removed from finger print reader 2.

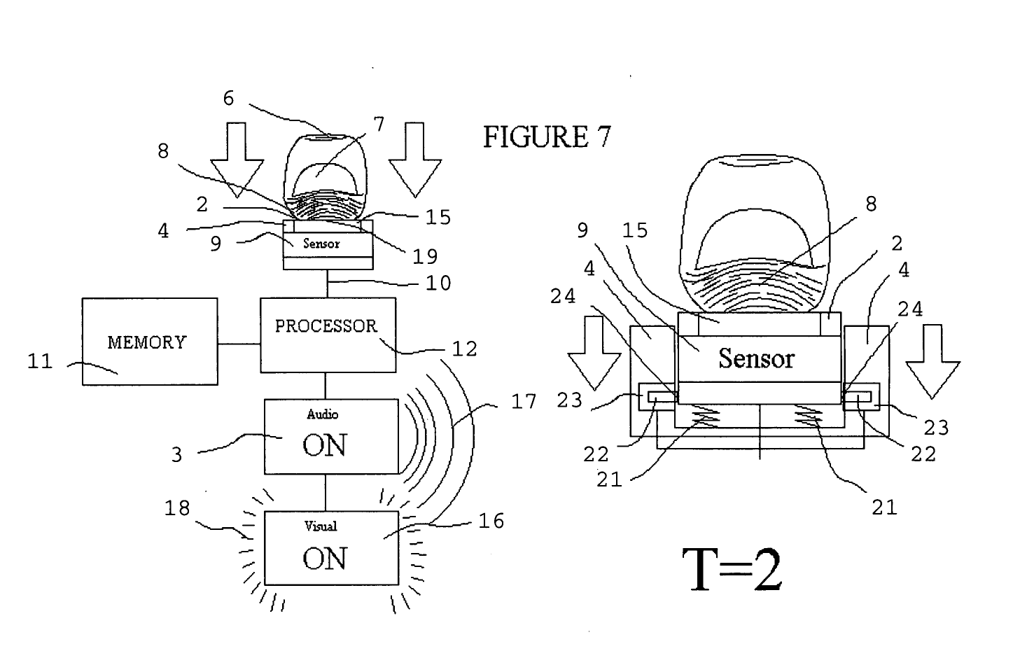

At time T=2, FIG. 7 shows the locking pins 24 in a retrieved position inside of cavity 22 of solenoid 23. After locking pins 24 are clear from finger print reader 2, the pressure from finger 5 pushing the slidable finger print reader 2 downwardly into the cavity of the housing 4. At this position, any mechanical locking means could be utilized to unlock a device. Even though many examples show the primary components enclosed in a housing special hopping encrypted codes will be sent out each time a user presses the bioswitch when the fingerprint authentication has failed. This will keep the security secret and also will avoid having any dual wire to short and defeat normal electrical switches.

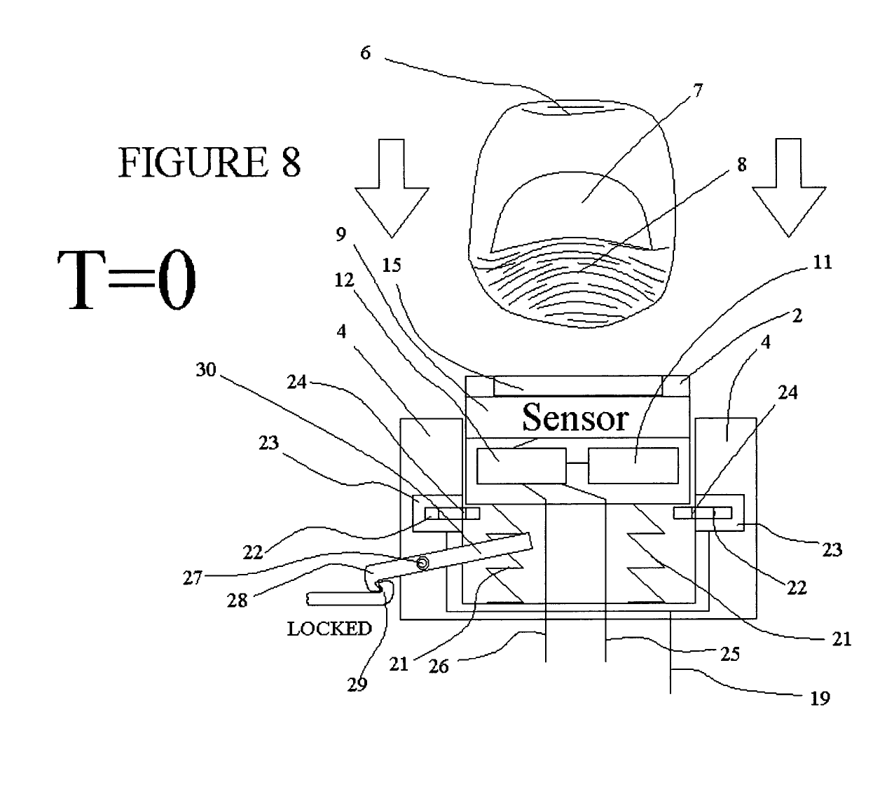

FIGS. 8-10 are analogous to FIGS. 6 and 7 with the exception that the primary components of the block flow diagram are integrated and enclosed within the housing 4 of the bioswitch. The processor and memory are integrated into the bioswitch making it totally standalone as an intelligent bioswitch. The mathematical algorithms needed to compare and match minutia points for a small number of users need little processing power and little memory storage for accurate and fast readings. Thus processing power and memory storage necessary for small numbers of users are easily integrated with the use of solid-state devices. Furthermore, these solid-state devices demand small amounts of power to operate, thus, internal battery can easily operate such devices.

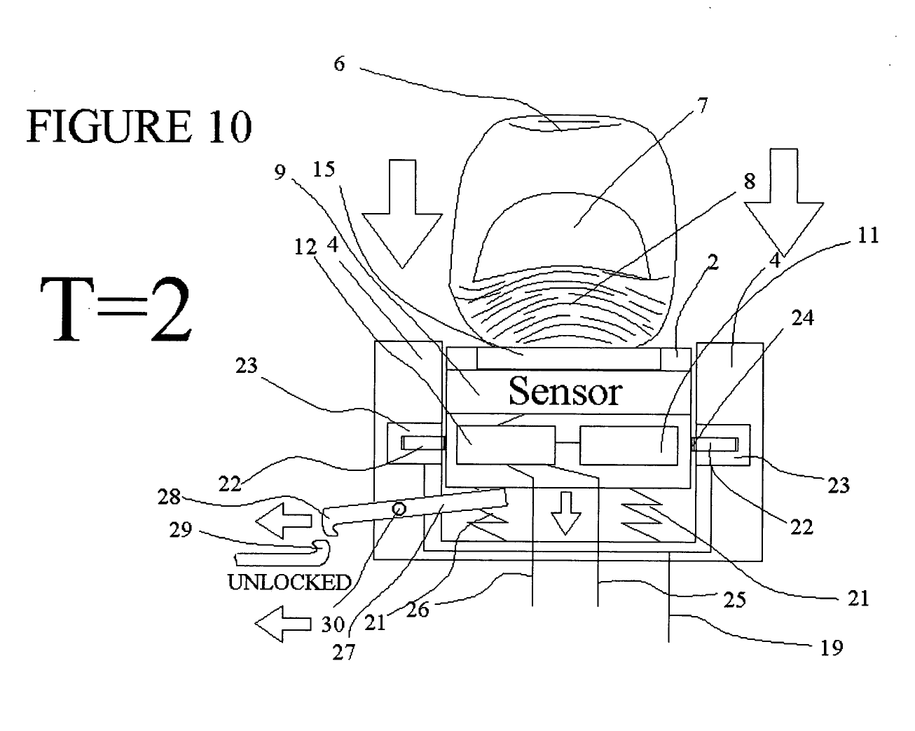

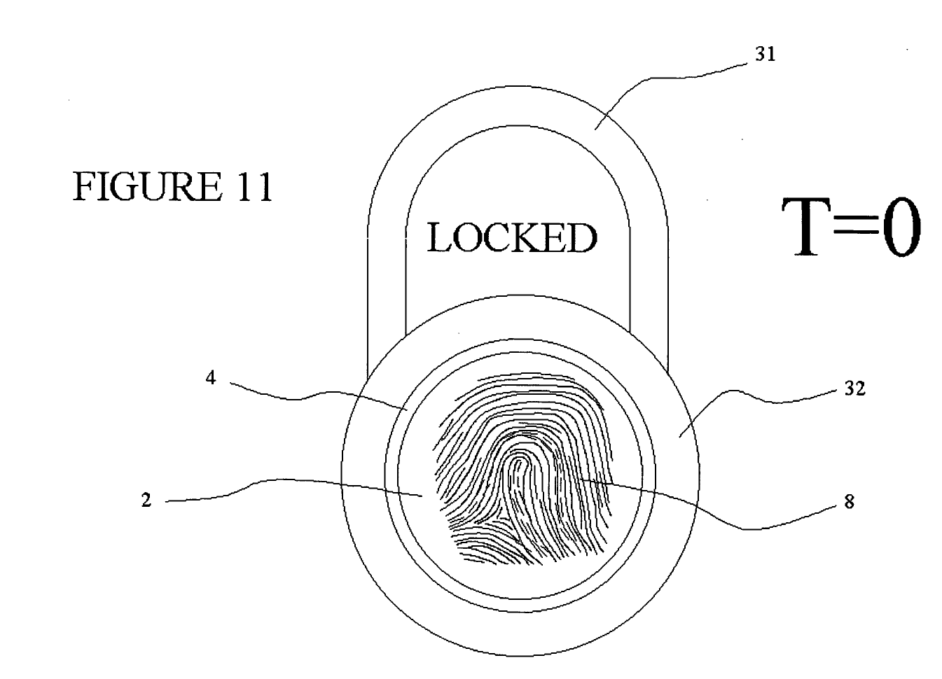

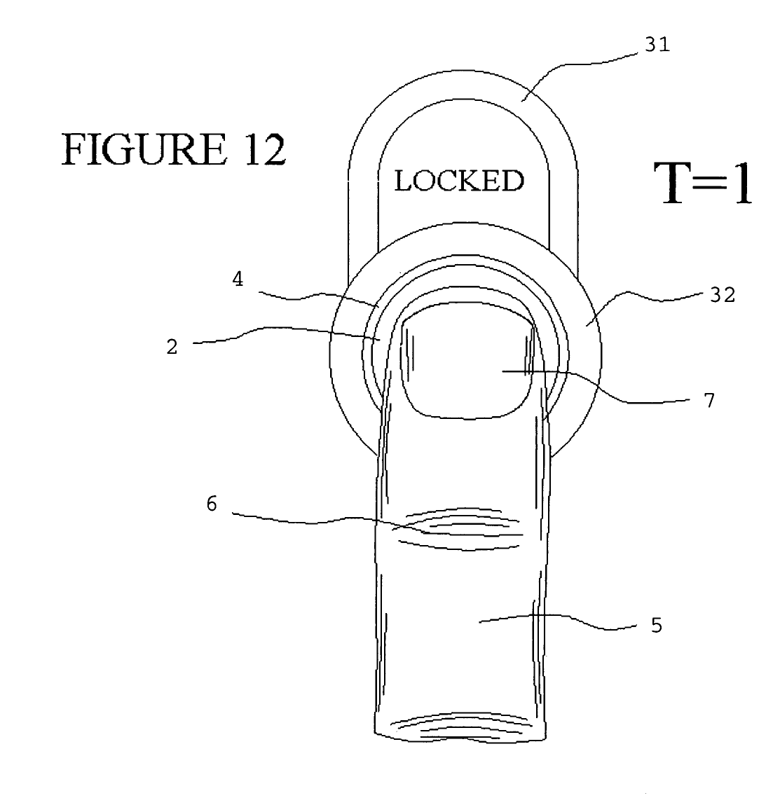

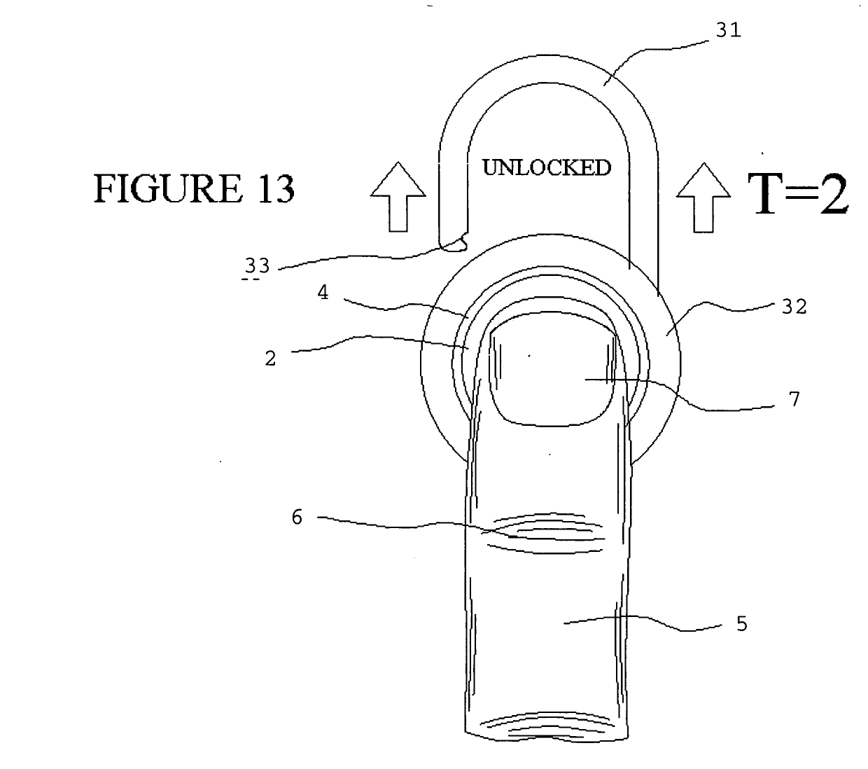

FIGS. 11-13 show an application of how the bioswitch can be used in the field with its inherent push button type finger print reader with tactile feedback. A padlock at time T=0 in FIG. 11 shows a padlock with a finger print reader replacing the typical number combination dial. A user simply places his fingerprint from his finger onto the surface of the finger print reader as shown in FIG. 12. The internal processor then reads the users fingerprint and matches the fingerprint with the stored data within. Once a correct match has been obtained, an electro mechanical means, normally a solenoid, activates and the pressure from the finger onto finger print reader allows the finger print reader to slide into the housing. As the finger print reader 2 slides into the housing 4, the reader 2 presses against a lever arm 27 as in FIG. 10 and unhooks a latch 33 similar to latch 28 and 29 as in FIG. 10. It should be noted that this particular example is a very general way of describing the means in which the bioswitch reads and opens a typical combination padlock. Other applications for the bioswitch include ignition switches for automobiles with only a few registered users allowed access.

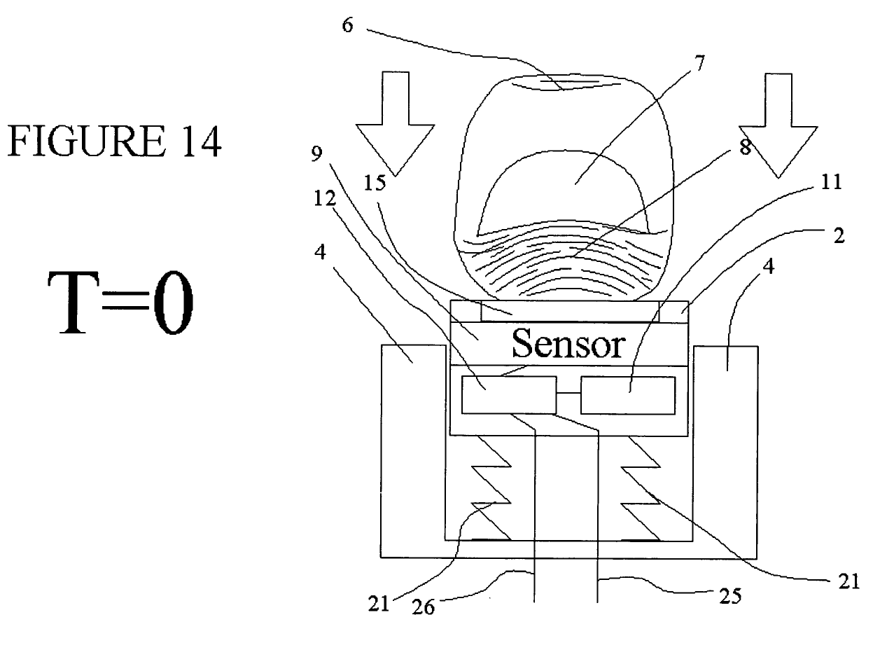

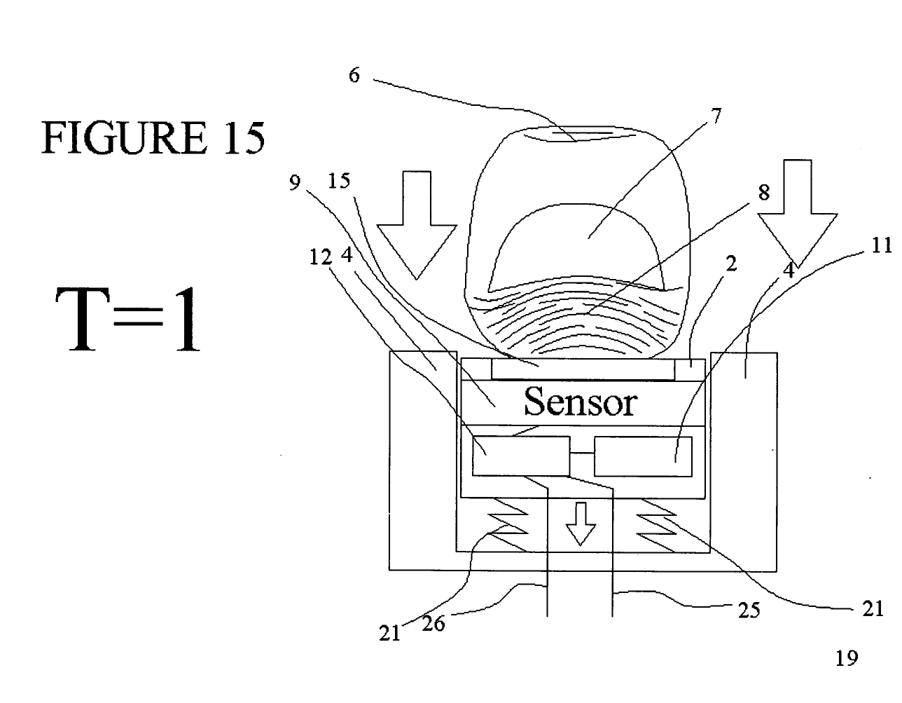

FIGS. 14 and 15 are very similar to FIGS. 8-10 with the exception that the internal solenoid switch and lever arms are removed from the bioswitch and housing. In this particular arrangement, the electric switch, lever arm, latches and other operating components used to lock and unlock a mechanism are remote. This arrangement allows for the internal springs 21 to be adjusted such that the proper amount of spring tension can be engineered for accurate fingerprint readings. When a user presses onto fingerprint reader 9, the reader 2 slides into housing 4 thereby compressing the springs 21. The tension of the springs 21 as in FIG. 15 resist compression allowing the surface area of the fingertip 7 to spread evenly over the fingerprint reading surface thereby giving a more accurate reading. The natural motion of pressing a momentary switch ensures the correct pressure and activation of scanning the fingerprint. By the time the user has fully pressed the switch scanning of the fingerprint is done. As the user is getting ready to release the switch the analysis and verification is done. When the processor 12 has determined the user to be allowed access, data is sent to a remote electric type switch or other means electromechanical means to perform whatever function the user has been allowed to perform.

In describing FIGS. 14 and 15, a user's finger is moves towards the switch, as the finger touches the switch, the user starts pressing the switch inward, due to the spring 21 behind the fingerprint reader 2, correct pressure is ensured. The bioswitch moves inside due to the initial fingerprint pressure overcoming the spring 21 tension. As this is happening, the processor starts scanning as soon as the switch reaches 50% or more of the inward motion. By the time bioswitch is fully pressed the scanning is already done and analysis and verification has started. Even, before the user realizes that the switch is fully pressed the indicators will indicate whether or not verification is successful or not. If verification is successful, the relay or mechanical lock will trigger immediately.

Since minor changes and modifications varied to fit particular operating requirements and environments will be understood by those skilled in the art, the invention is not considered limited to the specific examples chosen for purposes of illustration, and includes all changes and modifications which do not constitute a departure from the true spirit and scope of this invention as claimed in the following claims and reasonable equivalents to the claimed elements.

What is claimed is:

1. A finger print reading apparatus for reading finger prints and giving tactile feedback, said apparatus comprising:
a. a button having an upper surface, said button slidably affixed to a housing,
b. a finger print reader affixed to said upper surface of said button,
c. a processor communicating with said finger print reader,
d. a power supply electrically connected to said processor,
e. a memory storage communicating with said processor,
f. a means for electromechanically allowing said button to slide within said housing, said means communicating with said processor, said means powered by said power supply.

2. A fingerprint reading a set forth in claim 1 wherein said power supply is a miniature battery encased in said button.

3. A fingerprint reading a set forth in claim 1 wherein said processor communicating with a remote processor and memory storage.

4. A fingerprint reading a set forth in claim 3 wherein said communicating between said processor and said remote processor is wireless.
